(19) United States
(12) Patent Application Publication
(10) Pub. No.: US 2023/0022112 A1
(43) Pub. Date: Jan. 26, 2023

(54) MECHANISM FOR UNALTERABLE, NONREPUDIABLE CONFIGURATION AUDITING WITHIN CRYPTOGRAPHIC SELECTION SCHEMES

(71) Applicant: VMware, Inc., Palo Alto, CA (US)

(72) Inventors: Daniel James BEVERIDGE, Apollo Beach, FL (US); Mark BENSON, Workingham (GB); Marc Wayne BROTHERSON, Boulder, CO (US); Sean HUNTLEY, NSW (AU); Akeem JENKINS, Broomfield, CO (US); David OTT, Chandler, AZ (US)

(21) Appl. No.: 17/385,489

(22) Filed: Jul. 26, 2021

(51) Int. Cl. H04L 9/32; G06N 20/00

(52) U.S. Cl. CPC H04L 9/3236; H04L 9/321; G06N 20/00; H04L 2209/38

(57) ABSTRACT

The disclosure provides an approach for auditable cryptographic agility. Embodiments include receiving, by a cryptographic agility system, a request to perform a cryptographic operation related to an application. Embodiments include selecting, by the cryptographic agility system, a cryptographic technique for performing the cryptographic operation based on contextual information associated with the request. Embodiments include performing, by the cryptographic agility system, the cryptographic operation using the cryptographic technique. Embodiments include writing, by the cryptographic agility system, data related to selecting the cryptographic technique to a secure digital ledger.

### BACKGROUND

Cryptography generally involves techniques for protecting data from unauthorized access. For example, data transmitted over a network may be encrypted in order to protect the data from being accessed by unauthorized parties. For example, even if the encrypted data is obtained by an unauthorized party, if the unauthorized party cannot decrypt the encrypted data, then the unauthorized party cannot access the underlying data. There are many types of cryptographic algorithms, and these algorithms vary in many aspects such as key size, ciphertext size, memory requirements, computation requirements, amenability to hardware acceleration, failure handling, entropy requirements, and the like. Key size refers to the number of bits in a key used by a cryptographic algorithm. Ciphertext size refers to the number of bits in the output from a cryptographic algorithm, which may be the same as the number of bits of the input or may include padding to produce a larger number of bits than the input. Memory requirements and computation requirements generally refer to the amount of memory and processing resources required to perform an algorithm. Amenability to hardware acceleration generally refers to whether an algorithm requires or can be improved through the use of a hardware accelerator. For example, a compute accelerator is an additional hardware or software processing component that processes data faster than a central processing unit (CPU) of the computer. Failure handling refers to the processes by which an algorithm accounts for failures, such as recovering keys that are lost or deactivated. Entropy requirements generally refer to the amount of randomness required by an algorithm, such as an extent to which randomly generated values are used as part of the algorithm (e.g., which generally improves security of the algorithm).

Some cryptographic algorithms may result in a higher level of security (e.g., having more bits of security, more layers of security, larger amounts of entropy, and/or the like) than others, and there may be trade-offs with respect to resource requirements such that higher-security algorithms may require larger amounts of storage, processing, and/or communication resources (e.g., involving the transmission of larger amounts of information over a network). Furthermore, new cryptographic algorithms and libraries are developed on an ongoing basis to meet changing security needs. Cryptographic libraries are collections of cryptographic algorithms that can be invoked, such as through calls to application programming interface (API) functions provided by the libraries, in order to perform various cryptographic functions (e.g., encryption of data, establishing secure connection channels, and/or the like). In some cases, weaknesses in particular algorithms may be discovered over time such as due to advances in computing technology (e.g., a particular algorithm may be susceptible to being compromised through the use of computing devices with more power than the computing devices that were in use at the time the algorithm was developed). For example, algorithms may become problematic and/or become less useful for a variety of reasons, such as due to algorithmic compromise (e.g., a weakness in the algorithm may be discovered and/or exploited), compute performance increases (e.g., the time required to “guess correctly” may be reduced), and/or the like. In some cases, new and/or updated algorithms may be developed to address these issues (e.g., by adding additional bits of security, additional layers of security, more complex forms of encryption, and/or the like).

The rise of quantum computing has raised the possibility of additional issues related to cryptography. For example, the high levels of computational power provided by quantum computing may enable nefarious actors to more easily access data secured with existing cryptographic algorithms, thereby gaining access to sensitive data that was previously believed to be secure.

The dynamic nature of computing technology and the variety of threats that exist to data security necessitate a continuous adapting of cryptography to meet these new circumstances and threats. Furthermore, laws and/or regulations may require certain types of cryptography to be utilized in certain contexts. Thus, compliance with such laws and/or regulations may further necessitate adopting of new and/or different types of cryptographic algorithms.

Conventional software applications are generally designed to implement and/or utilize particular cryptographic algorithms. These algorithms may be customizable in certain respects, but there is generally no convenient mechanism for changing the cryptographic algorithms utilized by an application without modifying the base code of the application, essentially requiring portions of the application code to be rewritten, which is time consuming and difficult. Such code modifications are expensive and error-prone, particularly when done on a regular basis to address the ever-changing landscape of computing security.

Furthermore, if cryptographic algorithms or configurations are added to or removed from a set of available cryptographic techniques utilized by an application, it can be challenging to ensure that the cryptographic techniques utilized by the application in particular instances comply with relevant standards. For example, it may be difficult to audit specific cryptographic operations to ensure that the techniques that were used are compliant with relevant standards and are appropriate for the situations in which they were used.

As such, there is a need for improved cryptography techniques that allow for auditable cryptographic agility.

### BRIEF DESCRIPTION OF THE DRAWINGS

FIG. 1 is an illustration of example computing components related to auditable cryptographic agility, according to embodiments of the present disclosure.

FIG. 2 is an illustration of an example ledger related to auditable cryptographic agility.

FIG. 3 is an illustration of an example entry stored on a ledger related to auditable cryptographic agility.

FIG. 4 is an illustration of an example related to auditable cryptographic agility

FIG. 5 depicts example operations related to auditable cryptographic agility according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates to cryptographic agility. In particular, the present disclosure provides an approach for auditable cryptographic agility that involves maintaining a record of operations related to cryptographic agility on a secure digital ledger.

Cryptographic agility generally refers to techniques for dynamic selection and/or configuration of cryptographic algorithms. According to certain embodiments, logic related to selection and/or configuration of cryptographic algorithms is decoupled from the applications that utilize cryptographic functionality, and is implemented in one or more separate components. Thus, rather than an application directly calling a cryptographic library to perform cryptographic functionality, the application may call generic cryptographic functions provided by a separate cryptographic agility system, and the cryptographic agility system may then select and/or configure cryptographic algorithms, such as based on contextual information and/or policies. For instance, the cryptographic agility system may dynamically determine which libraries, algorithms, configuration values, and/or the like to select based on factors such as the type of data being encrypted, the type of application requesting encryption, the network environment(s) in which the data is to be sent, a destination to which encrypted data is to be sent, geographic locations associated with a source and/or destination of the data, attributes of users associated with the encryption, regulatory environments related to the encryption, network conditions, resource availability, performance constraints, device capabilities, and/or the like.

Dynamically selecting cryptographic techniques based on resource constraints is described in more detail in U.S. patent application Ser. No. 17/385,287, filed Jul. 26, 2021, the contents of which are incorporated by reference herein in their entirety.

In some embodiments, a proxy component may be utilized to enable cryptographic agility in legacy applications and services. Such a proxy component is described in more detail in U.S. patent application Ser. No. 17/385,401, filed Jul. 26, 2021, the contents of which are incorporated by reference herein in their entirety.

For example, policies may be defined by users (e.g., administrators), and may specify rules for selecting and/or configuring cryptographic algorithms. In one example, cryptographic techniques (e.g., algorithms and/or configurations of algorithms) are tagged with different levels of security (e.g., rated from 0-10), and a policy associated with an application may specify that all data that is to be transmitted from the application to a destination in a given type of networking environment, such as a public network, is to be encrypted using a high-security algorithm (e.g., rated 8 or higher). Thus, if the application sends data (e.g., whether encrypted directly by the application or not), and contextual information indicates that the data is to be transmitted to a device on a public network, then the cryptographic agility system, in certain embodiments, will select a cryptographic algorithm tagged as a high-security algorithm, such as with a security rating of 8 or higher.

By decoupling cryptographic logic from applications that rely on cryptographic functionality, techniques described herein provide flexibility and extensibility, thus allowing cryptographic algorithms to be continually updated, changed, and otherwise configured without requiring modifications to the applications themselves. Accordingly, changing circumstances and new threats may be addressed in a dynamic and efficient manner, and computing security may thereby be improved.

In some cases, cryptographic algorithms and/or configurations of algorithms may be dynamically switched over time based on changing circumstances. For example, if a client device moves from a low-latency network to a high-latency network (such as the latency of a network that device is coupled to changes), the cryptographic agility system may switch from a cryptographic algorithm that requires a large amount of network resources to an alternative cryptographic algorithm that requires smaller amounts of network resources (e.g., a lower security algorithm that still meets the security requirements for the cryptographic operation), and may switch back if the device moves again into a lower-latency network. These changing circumstances may be determined by the cryptographic agility system based on contextual information related to each communication from the application to the client device and vice-versa.

According to embodiments of the present disclosure, a secure digital ledger is used to provide an auditable record of operations related to cryptographic agility. An example of a secure digital ledger is an immutable hash chain (e.g., blockchain). Hash chains are data structures that record data in a fashion analogous to a chain. Each update to the chain creates a new block containing the data and each block is linked to the previous block by a cryptographic function. Blocks are generally appended to the end of the chain and, once in the chain, resist modification so that the cryptographic links in the chain are preserved. Entities (e.g., applications) that receive data from blocks of the chain may check the cryptographic links to test the validity of the chain. Any attempt to modify a block is detected and subject to remedial or other action. Hash chains are generally managed by peer-to-peer networks, which collectively adhere to an established protocol for validating each new block and are designed to be inherently resistant to modification of data. Once recorded, the data in any given block cannot be modified without the alteration of subsequent blocks and the involvement of the network. Thus, if records of operations related to cryptographic agility are written to such a secure digital ledger, these records can be trusted to be accurate, and can be relied upon for auditing purposes.

The secure digital ledger may be used to store records of selections of cryptographic techniques as well as, in some embodiments, updates to the cryptographic agility system, such as additions, removals, and/or modifications of cryptographic techniques and/or policies. For example, if a tag associated with a cryptographic technique in the cryptographic agility system is added, removed, or modified, a record of the action may be written to the secure digital ledger. In another example, if a policy in the cryptographic agility system is modified (e.g., to require a lower or higher level of security for certain situations), then a record of the action may be written to the secure digital ledger.

When a cryptographic technique is selected for servicing a cryptographic request, details related to the selection may be written to the secure digital ledger. For example, the details may include contextual information related to the request, the details of the request (e.g., what cryptographic operation was requested), any policies that were used in the selection, any characteristics of cryptographic techniques (e.g., tags) that were used in the selection, any other details of the selection process (e.g., an indication of the logic used to select a cryptographic technique), the cryptographic technique that was selected, and/or the like. Thus, the secure digital ledger will include a sequential, nonrepudiable record of all selections, updates, and/or other operations related to cryptographic agility.

Trust is a critically important factor in secure communications, and the use of cryptographic agility to automate aspects of cryptography, such as selection of cryptographic techniques, may raise issues of transparency. The use of a secure digital ledger to store records of operations related to cryptographic agility provides transparency for a cryptographic agility system, and allows all involved parties to trust the security of the system.

For instance, the secure digital ledger may allow for the operations of the cryptographic agility system to be audited (e.g., manually and/or automatically) for compliance with standards and/or for security analysis purposes. In one example, an auditing component analyzes records on the secure digital ledger to determine whether cryptographic techniques that are selected by the cryptographic agility system comply with applicable, laws, regulations, and/or other standards. The auditing component may further analyze cryptography selections and/or updates to policies and/or cryptographic techniques that are indicated in records on the secure digital ledger in order to determine whether any issues may be present. For instance, the auditing component may compare records on the secure digital ledger to patterns known to be associated with issues (e.g., malicious actors attempting to compromise the system). In one particular example, a malicious actor may modify a policy to allow lower-security cryptographic techniques to be utilized for sensitive information. The auditing component may detect this modification through analyzing the records on the secure digital ledger (e.g., and detecting a pattern, such as a policy change that lowers security for situations involving particular sensitivity), and may take remedial or other action (e.g., preventing the policy from being implemented without review by an administrator, generating an alert, and/or the like).

The auditing component may be a software or hardware component that is separate from the secure digital ledger, or may be located on the secure digital ledger, such as in the form of a smart contract. A “smart contract” generally refers to a self-executing program that automatically performs operations and maintains state information. Smart contracts are computerized transaction protocols that execute operations (e.g., auditing operations) through cryptographic code. When stored on a hash chain, smart contracts may be used to automatically analyze records of operations related to cryptographic agility according to particular conditions (e.g., rules and/or patterns related to security and/or compliance with standards) while providing complete visibility and preventing modification to the conditions (e.g., due to the transparent and immutable properties of hash chains).

In some embodiments, machine learning techniques may be utilized by an auditing component in order to detect potential issues and/or ensure compliance with one or more standards. For example, one or more machine learning models (e.g., neural networks, tree-based models, clustering models, and/or the like) may be trained based on historical records of operations associated with labels indicating whether the historical records were associated with issues, complied with one or more standards, and/or the like. Labels may be assigned to historical records by, for example, a subject matter expert. In some embodiments, s machine learning model is trained using supervised learning techniques to determine whether one or more records written to the ledger indicate a problem, comply with one or more standards, and/or the like. For instance, a smart contract utilizing such a machine learning model may be deployed on the ledger, and may analyze records as they are written to the ledger by providing inputs to the machine learning model based on the records and receiving outputs from the model indicating whether the records indicate potential issues, comply with one or more policies, and/or the like. In some cases, the machine learning model may be trained to recognize patterns involving one or more records that indicate potential issues.

Various actions may be performed to address issues detected by an auditing component (e.g., based on individual records, multiple records, patterns, and/or the like, with or without the use of machine learning models). For example, the auditing component may notify one or more entities related to a standard (e.g., governmental, administrative, corporate, or other entities) if it detects noncompliance with the standard. In another example, the cryptographic agility system may be notified of an issue so that it can take particular actions, such as disabling potentially problematic cryptographic techniques or policies. In another example, an alert may be generated if an issue is detected (e.g., a pattern indicating a potential security issue) so that an administrator can take action to address the issue.

As such, embodiments of the present disclosure improve upon conventional cryptography techniques in which cryptographic algorithms are pre-determined for applications (e.g., at design time) by allowing cryptographic algorithms and/or configurations to be dynamically selected and changed over time based on contextual information, even if an application was not designed to support such functionality. Furthermore, by utilizing a secure digital ledger to store records of operations related to cryptographic agility, techniques described herein provide improved trust, auditability, and security for cryptographic agility.

Additionally, techniques described herein may facilitate an organization's use of uniform policy configuration (e.g., a suite of coordinated policies), such as to orchestrate cryptographic usage across many hosts (e.g., for federated data centers deployed worldwide) in an auditable manner. Embodiments of the present disclosure may also be used to facilitate migration to new cryptographic algorithms at scale and/or to remove deprecated cryptographic algorithms from use in a centralized, coordinated, and auditable manner.

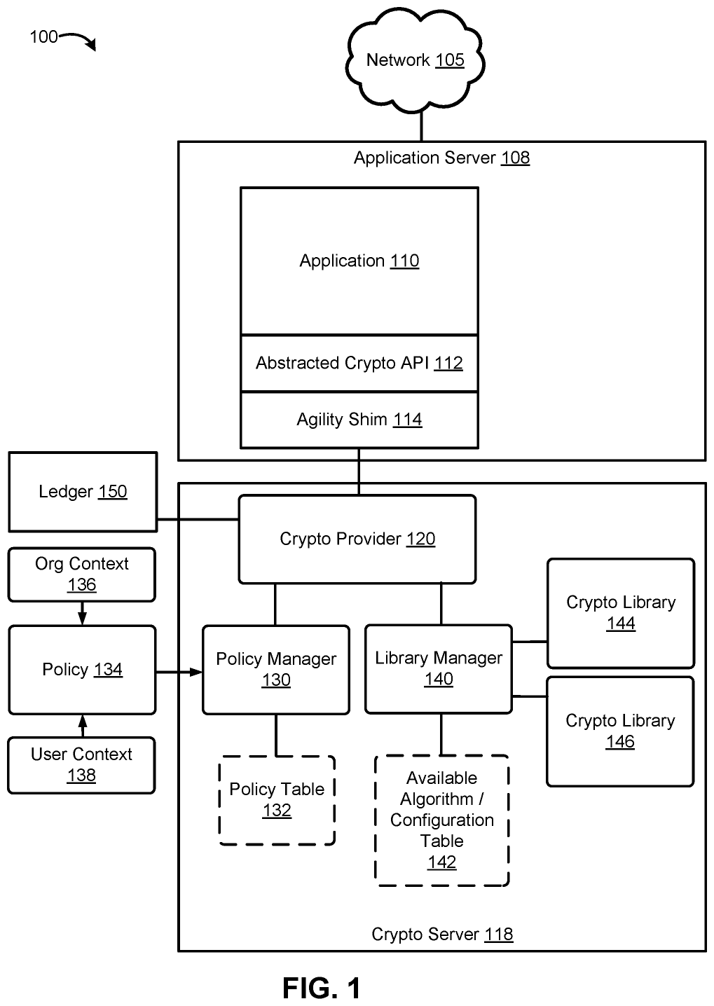

FIG. 1 is an illustration 100 of example computing components related to auditable cryptographic agility, according to embodiments of the present disclosure.

An application server 108 is connected to a network 105. In certain embodiments, application server 108 may be a physical or virtual computing device, such as a server computer, that hosts an application 110. In some embodiments, application server 108 may be a virtual computing instance (VCI), such as a virtual machine (VM) or container that runs on a physical host computer. Network 105 may be any sort of network over which data may be transmitted, such as a local area network (LAN), cellular network, satellite-based network, the Internet, or the like. It is noted that application server 108 is included as an example computing device on which application 110 and/or associated components may be located, and other types of devices may also be used.

Application 110 generally represents a software application that requires cryptographic functionality. For example, application 110 may rely on cryptographic functionality to encrypt data that it transmits over a network (e.g., network 105), such as to one or more client devices that interact with application 110 (e.g., accessing content provided by application 110). While conventional techniques generally involve direct integration of cryptographic libraries with applications that rely on cryptographic functionality, techniques described herein involve abstracting cryptographic functionality away from applications. As such, an agility shim 114 provides an abstracted crypto application programming interface (API) 112 as a means of facilitating cooperation between application 110 and a separate cryptographic agility system. In some embodiments, agility shim 114 may be located within a proxy component that intercepts communications between application 110 and external endpoints such as client devices.

Application 110 or the proxy component may call generic cryptographic functions of abstracted crypto API 112 in order to invoke particular cryptographic functionality, and the cryptographic agility system may select cryptographic techniques and perform cryptographic operations in response to the function invocations based on contextual information.

The cryptographic agility system includes agility shim 114 and abstracted crypto API 112 as well as crypto provider 120, policy manager 130, and library manager 140. In some embodiments, while depicted as separate components, agility shim 114, abstracted crypto API 112, policy manager 130, and/or library manager 140 may be part of crypto provider 120. In certain embodiments, abstracted crypto API 112 and/or agility shim 114 are part of a proxy component located on application server 108. In alternative embodiments, abstracted crypto API 112 and/or agility shim 114 may be located on a proxy component separate from application server 108, such as on crypto server 118 or a different computing device.

Agility shim 114 may comprise a library, and generally intercepts API calls (e.g., calls to functions of abstracted crypto API 112) and redirects them to crypto provider 120. Shims generally allow new software components to be integrated with existing software components by intercepting, modifying, and/or redirecting communications. As such, agility shim 114 allows application 110 or a proxy component associated with application 110 to interact with crypto provider 120 even though the proxy component and/or application 110 itself may have no knowledge of crypto provider 120. For instance, application 110 or the proxy component may make generic cryptographic function calls (e.g., requesting that an item of data be encrypted), and these generic function calls may be intercepted by agility shim 114 and redirected to crypto provider 120.

It is noted that while embodiments of the present disclosure are depicted on application server 108 and crypto server 118, alternative embodiments may involve various components being located on more or fewer computing devices. In some cases, aspects of the cryptographic agility system may be implemented in a distributed fashion across a plurality of computing devices. In certain embodiments, said components may be located on a single computing device.

In certain embodiments, crypto server 118 comprises a physical or virtual computing device, such as a server computer, on which components of the cryptographic agility system, such as crypto provider 120, policy manager 130, and/or library manager 140, reside. For example, crypto server 118 may represent a VCI or a physical computing device. Crypto server 118 may be connected to network 105 and/or one or more additional networks.

Crypto provider 120 generally performs operations related to dynamically selecting cryptographic techniques (e.g., based on contextual information related to requests for cryptographic operations), performing the requested cryptographic operations according to the selected techniques, and providing results of the operations to the requesting components. Cryptographic techniques may include cryptographic algorithms (e.g., included in one or more libraries) and/or specific configurations of cryptographic algorithms, as described herein. In some embodiments, the cryptographic agility system is located on the same device as application 110, while in other embodiments the cryptographic agility system is located on a separate device, such as on a server that is accessible over a network.

In certain aspects, crypto provider 120 has two major subsystems, policy manager 130 and library manager 140. Policy manager 130 performs operations related to cryptographic policies, such as receiving policies defined by users and storing information related to the policies in a policy table 132. In an example, a policy 134 is based on one or more of an organizational context 136 and a user context 138 related to a cryptographic request.

Organizational context 136 may involve geographic region (e.g., country, state, city and/or other region), industry mandates (e.g., security requirements of a particular industry, such as related to storage and transmission of medical records), government mandates (e.g., laws and regulations imposed by governmental entities, such as including security requirements), and the like. For instance, policy 134 may indicate that if a cryptographic request is received in relation to a device (e.g., client device or other device, such as application server 108) associated with a particular geographic region, associated with a particular industry, and/or within the jurisdiction of a particular governmental entity, then crypto provider 120 must select a cryptographic technique that meets one or more conditions (e.g., having a particular security rating and/or being configured to protect against particular types of threats) in order to comply with relevant laws, regulations, or mandates.

User context 138 may involve user identity (e.g., a user identifier or category, which may be associated with particular privileges), data characteristics (e.g., whether the data is sensitive, classified, or the like), application characteristics (e.g., whether the application is a business application, an entertainment application, or the like), platform characteristics (e.g., details of an operating system), device characteristics (e.g., hardware configurations and capabilities of the device, resource availability information, and the like), device location (e.g., geographic location information, such as based on a satellite positioning system associated with the device), networking environment (e.g., a type of network to which the device is connected, such as a satellite or land-based network connection), and/or the like. For example, policy 134 may indicate that if a cryptographic request is received in relation to a particular category of user (e.g., administrators, general users, or the like), relating to a particular type of data (e.g., tagged as sensitive or meeting characteristics associated with sensitivity, such as being financial or medical data), associated with a particular application or type of application, associated with a particular platform (e.g., operating system), associated with a device with particular capabilities or other attributes (e.g., a client or server device having a certain amount of processing or memory resources, or having an accelerator), and/or in relation to a device in a particular location (e.g., geographic location) or type of networking environment (e.g., cellular network, satellite-based network, land network, or the like), then crypto provider 120 should select a cryptographic technique that meets one or more conditions. In some cases, a policy 134 may relate to resource constraints (e.g., based on available processing, memory, or network resources), such as specifying that cryptographic techniques must be selected based on resource availability (e.g., how much of a device's processing and/or memory resources are currently utilized, how much latency is present on a network, and the like) and/or capabilities (e.g., whether a device is associated with an accelerator) associated with devices and/or networks, while in other embodiments crypto provider 120 selects cryptographic techniques based on resource constraints independently of policy manager 130 (e.g., for all cryptographic requests regardless of whether any policies are in place). For example, policies may only relate to security levels of cryptographic techniques, such as requiring the use of cryptographic techniques associated with particular security ratings when certain characteristics are indicated in contextual information related to a cryptographic request, and resource constraints may be considered separately from policies. In one example, once all cryptographic techniques meeting the security requirements for a cryptographic request are identified based on policies, a cryptographic technique is selected from these policy-compliant cryptographic techniques based on resource constraints.

Policy table 132 stores information related to policies, such as policy 134. In some embodiments, policy table 132 maps various contextual conditions (e.g., relating to organizational context 136 and/or user context 138) to cryptographic technique characteristics (e.g., security ratings, threats protected against, resource utilization ratings, and the like). For example, a contextual condition may be the use of a certain type of application, a certain type of data, or a particular geographic location. A cryptographic technique characteristic may be, for example, a security rating (e.g., 0-10), whether the cryptographic technique is quantum-safe, what level of resource requirements the cryptographic technique has for a particular type of resource (e.g., memory, processor, or network resources), or the like. Thus, when cryptographic requests are received, policy table 132 is used to determine whether the cryptographic requests are associated with any characteristics included in policies and, if so, what cryptographic technique characteristics are required by the policies for servicing the requests.

Library manager 140 generally manages cryptographic libraries containing cryptographic algorithms. For example crypto libraries 144 and 146 each include various cryptographic algorithms, each of which may include configurable parameters, such as key size or ciphertext size. For instance, cryptographic techniques (e.g., algorithms and/or specific configurations of algorithms) may be registered with library manager 140 along with information indicating characteristics of the cryptographic techniques. Examples of algorithms include data encryption standard (DES), triple DES, advanced encryption standard (AES), and Rivest-Shamir-Adleman (RSA). An algorithm may, for example, involve symmetric key encryption or asymmetric key encryption. A configuration of an algorithm may include values for one or more configurable parameters of the algorithm, such as key size, size of lattice, which elliptic curve is utilized, number of bits of security, whether accelerators are used, ciphertext size, and/or the like. A characteristic of a cryptographic technique may be, for example, a security rating, a resource requirement rating, whether the technique requires an accelerator, whether the technique is quantum-safe, or the like. A cryptographic technique may include more than one cryptographic algorithm and/or configuration. In an example, each cryptographic technique is tagged (e.g., by an administrator) based on characteristics of the technique, such as with a security rating, an indication of threats protected against by the technique, indications of the resource requirements of the technique, and/or the like.

Information related to cryptographic techniques registered with library manager 140 is stored in available algorithm/configuration table 142. For instance, available algorithm/configuration table 142 may store identifying information of each available cryptographic technique (e.g., an identifier of a library, an identifier of an algorithm in the library, and/or one or more configuration values for the algorithm) associated with tags indicating characteristics of the technique. It is noted that policies and tags are examples of how cryptographic techniques may be associated with indications of characteristics, and alternative implementations are possible. For instance, rather than associating individual cryptographic techniques with tags, alternative embodiments may involve associating higher-level types of cryptographic techniques with tags, and associating individual cryptographic techniques with indications of types. For example, a higher-level type of cryptographic technique may be “symmetric key encryption algorithms configured with a key size of 200 bits or larger.” Thus, if tags are associated with this type (e.g., including security ratings, recourse requirement ratings, and the like), any specific cryptographic techniques of this type (being symmetric key encryption algorithms, and being configured with a key size of 200 bits or more) will be considered to be associated with these tags. In another example, fuzzy logic and/or machine learning techniques may be employed, such as based on historical cryptographic data indicating which cryptographic techniques were utilized for cryptographic requests having particular characteristics.

By allowing cryptographic techniques and libraries to be registered and deregistered with library manager 140 on an ongoing basis, embodiments of the present disclosure allow the pool of possible cryptographic techniques to be continuously updated to meet new conditions and threats. For example, as new libraries are developed, these libraries may be added to library manager 140, and the cryptographic techniques in the library may be used by crypto provider 120 in servicing requests from application 110 without application 110 having any awareness of the new libraries. Similarly, by managing policies and libraries separately, policies may be defined in an abstract manner (e.g., based on characteristics of requests and cryptographic techniques) such that policies may be satisfied through the selection of new cryptographic techniques that were not known at the time of policy creation.

In one particular example, a new cryptographic technique is tagged as quantum safe, meaning that the cryptographic technique was developed to be resistant to being decoded by quantum computers. For instance, the new cryptographic technique may have a high security rating (e.g., 10 out of 10) as well as high resource requirements. The new cryptographic technique is registered with library manager 140, and information about the new cryptographic technique and its characteristics is stored in available algorithm/configuration table 142. Thus, the new cryptographic algorithm is available to be selected by crypto provider 120 for servicing cryptographic requests from the proxy component related to application 110.

Continuing with the example, a policy 134 states that cryptographic requests relating to data that is long-lived (e.g., of a type that must be protected over a long amount of time, such as many years) is to be encrypted using a quantum-safe cryptographic technique if such a technique is available, unless device and/or network resource constraints prohibit the use of such a technique. Long-lived data may include, for example, classified government data, certain types of personally-identifiable information, and the like. Data that is not long-lived may include, for example, a code or password that expires after a short amount of time, a credit card number that is updated at regular intervals, network configuration data that changes on a regular basis, and the like.

Thus, when the proxy component related to application 110 submits a cryptographic request (e.g., via a call to a generic cryptographic function provided by abstracted crypto API 112) to encrypt an item of long-lived data (e.g., received from application 110 and directed to an endpoint), crypto provider 120 determines based on information stored in policy table 132 that a quantum-safe cryptographic technique is to be used if possible. Crypto provider 120 determines based on information in available algorithm/configuration table 142 that the new cryptographic technique is quantum-safe. Next, crypto provider 120 analyzes resource constraints related to the cryptographic request to determine if the new cryptographic technique can be performed. If crypto provider 120 determines that the device and/or network associated with application 110 can support the new cryptographic technique (e.g., based on available resources), then crypto provider 120 selects the new cryptographic technique for servicing the cryptographic request, and provides a response to application 110 or the proxy component (e.g., via agility shim 114) accordingly. In some cases, the response sent from crypto provider 120 to application 110 or the proxy component includes data encrypted using the selected technique. In other cases, the response includes information related to performing the selected technique to encrypt the data, and the encryption is performed by the entity from which the request was sent.

In some cases, more than one cryptographic technique may be selected for servicing a given cryptographic request. For instance, an item of data may first be encrypted using a first technique (e.g., that satisfies one or more first conditions related to policy and/or resource considerations) and then the encrypted data may be encrypted again using a second technique (e.g., that satisfies one or more second conditions related to policy and/or resource considerations).

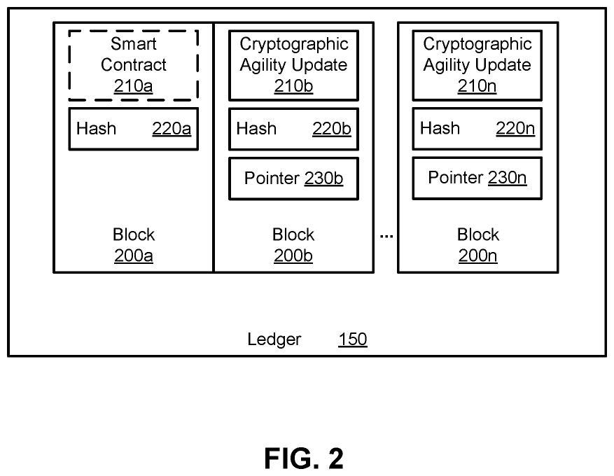

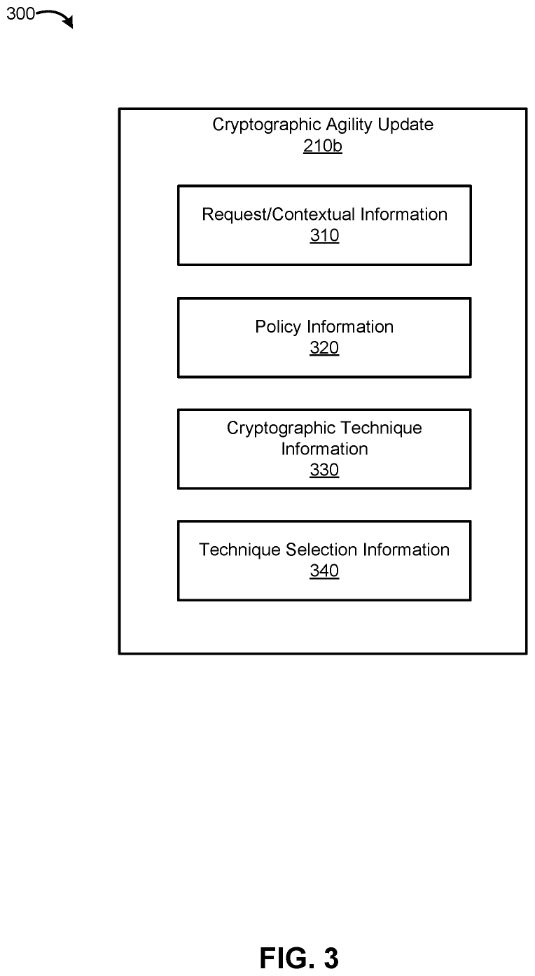

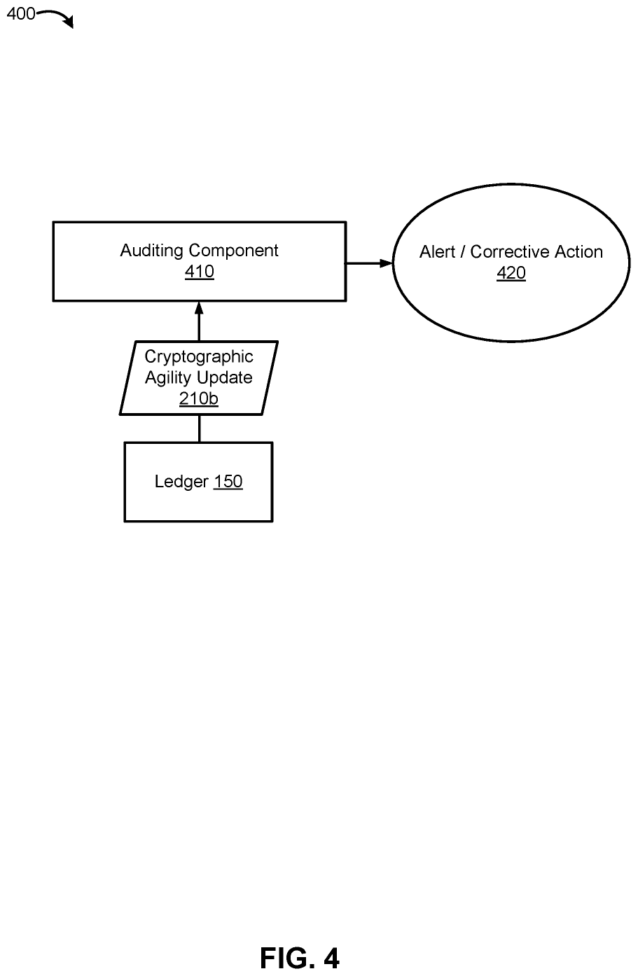

According to embodiments of the present disclosure, records of operations related to cryptographic agility are written to a ledger 150. Ledger 150 generally represents a secure digital ledger, such as a hash chain, that is modification-resistant. In one example, ledger 150 is a blockchain. Writing records of operations related to cryptographic agility is described in more detail below with respect to FIGS. 2 and 3. Auditing data written to ledger 150 is described in more detail below with respect to FIG. 4. Ledger 150 may be located on crypto server 118, application server 108, and/or one or more other devices. In one example, ledger 150 is implemented in a distributed fashion across a plurality of computing devices.

In an example, crypto provider 120 (and/or agility shim 114 and/or one or more other components of the cryptographic agility system) writes records of various operations to ledger 150, such as records of selections of cryptographic techniques, updates to policy table 132, updates to available algorithm/configuration table 142, and/or the like. For instance, crypto provider 120 may cause a new block to be appended to a chain in ledger 150 each time an operation related to cryptographic agility is performed.

FIG. 2 is an illustration of an example modification-resistant ledger 150 related to auditable cryptographic agility. FIG. 2 includes ledger 150 of FIG. 1. Ledger 150 comprises a series of blocks 200a-n. It is noted that ledger 150 may be independent of any particular computing device, and copies of all or portions of ledger 150 may exist on a plurality of devices. Block 200a contains smart contract 210a and a hash 220a (e.g., a hash of smart contract 210a). Smart contract 210a is an example embodiment of an auditing component that may perform auditing functions for data stored on ledger 150. In alternative embodiments, an auditing component is separate from ledger 150. Auditing is described in more detail below with respect to FIG. 4.

Blocks 200b-n each comprise a cryptographic agility update 210b-n, a hash 220b-n (e.g., hashes of cryptographic agility updates 210b-n), and a pointer 230b-n to the previous block. In another embodiment (not depicted), block 200a may have a pointer with a null value indicating that it is the first block in the hash chain.

Hashes 220 are generally determined (e.g., by a management component of ledger 150) at the time each respective block 200 is added to the chain by applying a hash function to the payload 210 (e.g., smart contract 210a and cryptographic agility updates 220b-n) stored in the block 200. In some embodiments, hashes 220 may serve as identifiers for blocks 200. The integrity of ledger 150 may be verified, such as for auditing purposes, by traversing the chain using pointers 230 and applying the hash function to the payload 210 of each block 200 and comparing the result to the corresponding hash 220.

Each block 200 may be added to ledger 150 (e.g., at the request of crypto provider 120 of FIG. 1 and/or one or more other entities) according to an established protocol for appending new blocks to the chain, such as a consensus protocol or a trusted authority protocol, as known in the art. In certain embodiments, “miners” may be employed to ensure the integrity of modifications to the chain, as known in the art.

For example, crypto provider 120 of FIG. 1 may send cryptographic agility updates 210b-n to ledger 150 for storage on the chain, and blocks 200b-n may be appended to the chain to store the updates. A given cryptographic agility update, such as cryptographic agility update 210b, may represent a record of an operation related to cryptographic agility, such as a selection of a cryptographic algorithm for servicing a cryptographic request, a policy update, a cryptographic technique update, or the like.

For example, each time a policy is added, removed, or modified in policy manager 130 of FIG. 1, a cryptographic agility update may be written to ledger 150. In another example, each time a cryptographic technique is added, removed, or modified in library manager 140 of FIG. 1, a cryptographic agility update is written to ledger 150. In certain embodiments, each time a cryptographic technique is selected by crypto provider 120 of FIG. 1 for servicing a cryptographic request, a cryptographic agility update is written to ledger 150.

Cryptographic agility updates generally include data related to operations that were performed. For example, if the operation is a policy or library operation (e.g., addition, removal, or modification of a policy or cryptographic technique), the corresponding cryptographic agility update may include details of the policy or library operation (e.g., indicating what was added, removed, or changed), details of the relevant policy or cryptographic technique (e.g., an identifier, rules specified in a policy, characteristics of a cryptographic technique, and/or the like), an identity of a user or other entity that performed the policy or library operation, a date and time at which the policy or library operation was performed, and/or the like.

In another example, as described in more detail below with respect to FIG. 3, if the operation if a selection of a cryptographic technique for servicing a cryptographic request, the corresponding cryptographic agility update may include information about the cryptographic request (e.g., a source of the request, what cryptographic operation was requested, and the like), contextual information related to the request (e.g., organization context, user context, and the like), any policies that were applied when selecting the cryptographic technique, characteristics (e.g., tags) of cryptographic techniques that were used in selecting the cryptographic technique, the cryptographic technique that was selected, and/or other information related to selecting the cryptographic technique (e.g., the logic that resulted in the selection).

Ledger 150 may allow for auditing of operations related to cryptographic agility. In some embodiments ledger 150 is publicly accessible, while in other embodiments ledger 150 is private. For example, access to ledger 150 may be allowed only to entities authorized for auditing purposes. In certain embodiments, ledger 150 is private, and auditing is performed by one or more entities with access to ledger 150 (e.g., smart contract 210a), and results of audits (e.g., indicating compliance or noncompliance with one or more standards) are provided to external entities upon request (e.g., without providing the underlying payloads 210 to the external entities). Even if ledger 150 is not public, external entities can trust the results of audits performed on ledger 150 due to the immutable and secure nature of ledger 150 (e.g., if the code of the auditing component such as a smart contract and the cryptographic agility system can be attested to in a private ledger).

It is noted that techniques described herein may utilize a newly created ledger or a previously-existing ledger. For example, in some embodiments, records of operations related to cryptographic agility may be written to one or more portions of an existing hash chain.

Furthermore, in some embodiments, a write to the ledger may occur before execution of an operation in order to register the intent of the system, For example, this may be used to prevent errors at runtime. An auditing component may recognize an intent from a pre-execution record written to the ledger, and may disapprove of operations determined to be inconsistent with one or more policies. For example, the auditing component could prevent the operation for occurring or otherwise generate an alert related to the operation in the event that an irregularity is detected based on a pre-execution record. Furthermore, in some embodiments the cryptographic agility system verifies the presence of a pre-execution record on the ledger prior to performing the operation indicated in the record, such as to ensure that a malicious actor did not block the record from being written to the ledger. Furthermore, when a configuration change occurs (e.g., a policy change, a change to one or more cryptographic techniques and/or associated tags, and/or the like), the cryptographic agility system may write a record of the change to the ledger and then verify the presence of the record on the ledger prior to taking any additional actions based on the change (e.g., prior to implementing any added or modified policies, using any added or modified cryptographic techniques, relying on any added or modified tags, and/or the like), such as to ensure that the record was not blocked. Thus, techniques described herein may allow for error checking and code compliance policies to be implemented.

FIG. 3 is an illustration 300 of an example entry stored on a modification-resistant ledger (e.g., ledger 150 of FIGS. 1 and 2) related to auditable cryptographic agility. Illustration 300 includes cryptographic agility update 210b of FIG. 2.

Cryptographic agility update 210b include request/contextual information 310, policy information 320, cryptographic technique information 330, and technique selection information 340.

Request/contextual information 310 generally includes information related to a request to perform a cryptographic operation that was received by a cryptographic agility system. Request/contextual information 310 may include the request itself, an identity of a component from which the request was received, a cryptographic operation that was requested to be performed, details of data to which the cryptographic operation relates (e.g., characteristics of data to be encrypted), characteristics, resource constraints, and/or capabilities of devices and/or networks related to the request, geographic locations associated with the request, users associated with the request, information about applications associated with the request, and/or the like.

Policy information 320 generally includes information related to any policies that were applied as part of the process for selecting the cryptographic technique, such as identifiers of such policies and/or rules indicated in such policies.

Cryptographic technique information 330 generally includes information about the selected cryptographic technique and/or other cryptographic techniques considered but not selected, such as identifiers, tags (e.g., indicating security ratings, resource utilization ratings, and/or the like), libraries to which techniques correspond, configuration information that is used in the techniques, and/or the like.

Technique selection information 340 generally includes other information related to selection of the cryptographic technique, such as an indication of the logic relied upon to select the cryptographic technique. For instance, technique selection information 340 may indicate that the cryptographic technique was selected because it had a security rating that complied with one or more particular policies and/or because it had one or more resource utilization ratings that complied with one or more resource constraints related to the request.

FIG. 4 is an illustration 400 of an example related to auditable cryptographic agility. Illustration 400 includes ledger 150 of FIGS. 1 and 2 and cryptographic agility update 210b of FIGS. 2 and 3.

Auditing component 410 generally represents a software or hardware component that performs auditing for data stored in ledger 150. In one example, auditing component 410 is implemented as one or more smart contracts, such as smart contract 210a of FIG. 2. In another example, auditing component 410 represents one or more separate components from ledger 150.

Auditing component 410 receives cryptographic agility update 210b from ledger 150, and analyzes cryptographic agility update 210b according to one or more rules, standards, and/or patterns. For example, auditing component 410 may determine, based on cryptographic agility update 210b, whether the cryptographic technique selected for servicing a particular cryptographic request was compliant with one or more standards (e.g., laws, regulations, or other standards). In some cases, auditing component 410 generates alerts and/or performs corrective action 420 based on results of auditing. For example, if auditing component 410 determines that a selected cryptographic technique does not comply with an applicable standard, auditing component 410 may alert one or more entities of the noncompliance and/or take action to correct the noncompliance, such as notifying the cryptographic agility system to switch to a compliant cryptographic technique.

In another example, auditing component 410 determines whether a change to a cryptographic technique in library manager 140 of FIG. 1, as indicated in a record on ledger 150, matches a pattern associated with a security issue. For example, a decrease of more than a threshold amount to a processing resource utilization tag of a cryptographic technique may be associated with an attempted security breach. Such a change may be made by a malicious actor in order to cause the cryptographic agility system to select a processing-intensive technique for a situation in which the processing resources on a device related to a request cannot support such a technique, thereby overloading the device. Such an attack is sometimes referred to as a Denial-of-Service (DoS) attack. A DoS attack is an attack meant to shut down a machine or network, making it inaccessible to its intended users.

Thus, if auditing component 410 detects that a tag associated with a cryptographic technique was modified to decrease a processing resource utilization rating more than a threshold amount, auditing component 410 may determine that this change matches a pattern associated with a known security issue, and may take action 420 accordingly. For instance, auditing component 410 may alert one or more entities about the potential DoS attach and/or may notify the cryptographic agility system to roll back the tag change or otherwise take action to avoid overloading any devices.

In an alternative example, if a resource utilization tag associated with a cryptographic technique is raised more than a threshold, this change may match a pattern associated with a downgrade attack. A downgrade attack generally causes a system to use a downgraded algorithm. By artificially increasing the resource utilization rating indicated in a tag of a cryptographic algorithm, such an attack may cause the cryptographic agility system to select the technique believing that it has a higher resource utilization rating, when it in fact has a lower resource utilization rating (e.g., because it is a low-security technique). Thus, if the auditing component detects such a pattern, it may take action to address the potential downgrade attack.

It is noted that the auditing examples described herein are not limiting, and many other types of auditing and/or verification operations may be performed based on data stored in ledger 150.

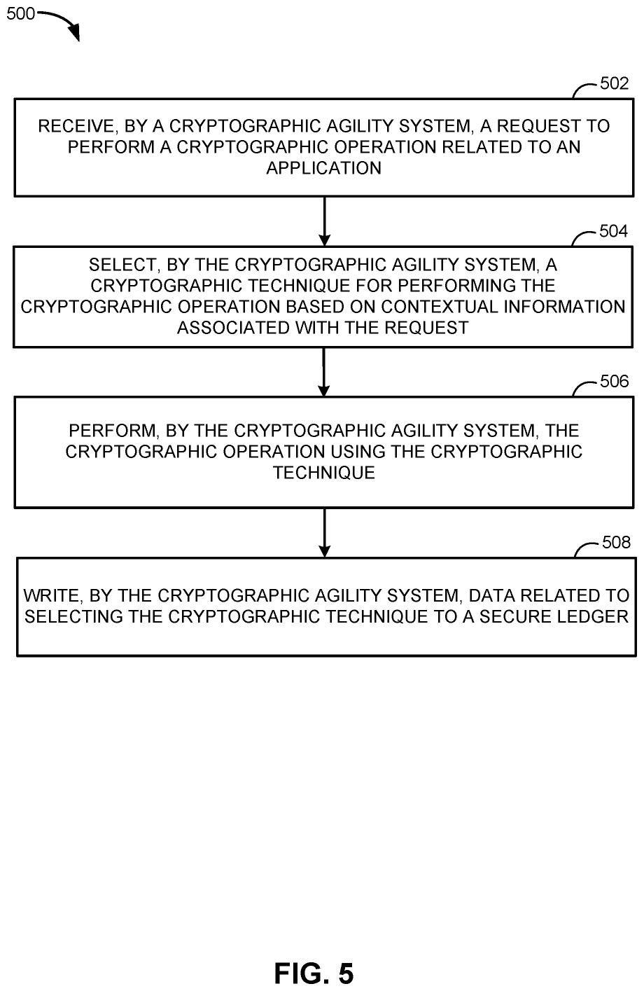

FIG. 5 depicts example operations 500 related to auditable cryptographic agility according to embodiments of the present disclosure. For example, operations 500 may be performed by one or more components of the cryptographic agility system described above with respect to FIGS. 1-4.

Operations 500 begin at step 502, with receiving, by a cryptographic agility system, a request to perform a cryptographic operation related to an application.

Operations 500 continue at step 504, with selecting, by the cryptographic agility system, a cryptographic technique for performing the cryptographic operation based on contextual information associated with the request. For example, the cryptographic agility system may apply one or more policies and/or may compare aspects of the contextual information to characteristics of the plurality of cryptographic techniques (e.g., indicated in tags) in order to select the cryptographic technique.

Operations 500 continue at step 506, with performing, by the cryptographic agility system, the cryptographic operation using the cryptographic technique.

Operations 500 continue at step 508, with writing, by the cryptographic agility system, data related to selecting the cryptographic technique to a secure digital ledger. The secure digital ledger may be, for example, a hash chain.

In some embodiments, writing, by the cryptographic agility system, the data related to selecting the cryptographic technique to the secure digital ledger comprises writing, to the secure digital ledger, indications of: the contextual information; the cryptographic technique; and one or more characteristics of the cryptographic technique related to selecting the cryptographic technique. In some cases, writing, by the cryptographic agility system, the data related to selecting the cryptographic technique to the secure digital ledger further comprises writing, to the secure digital ledger, an indication of one or more policies related to selecting the cryptographic technique.

Some embodiments further include analyzing, by an auditing component, the data related to selecting the cryptographic technique on the secure digital ledger to determine compliance with one or more conditions. In one example, the auditing component comprises a self-executing program on the secure digital ledger. The analyzing, in some cases, may involve the use of one or more machine learning models. In some embodiments, based on the analyzing, one or more remedial actions or notifications are performed by the auditing component or one or more third parties.

Certain embodiments further include determining, by the cryptographic agility system, an update comprising an addition, removal, or modification of a given policy or a given cryptographic technique and writing, by the cryptographic agility system, information related to the update to the secure digital ledger. In some embodiments, writing the data related to selecting the cryptographic technique to the secure digital ledger occurs prior to performing the cryptographic operation using the cryptographic technique, and the data related to selecting the cryptographic technique written to the secure digital ledger is used (e.g., by the cryptographic agility system or an auditing component) in determining to proceed with performing the cryptographic operation using the cryptographic technique.

Some embodiments further include writing, by the cryptographic agility system, a pre-execution record related to selecting the cryptographic technique to the secure digital ledger prior to performing the cryptographic operation using the cryptographic technique. For instance, the pre-execution record may be used by an auditing component to determine whether to allow the operation to be performed, and/or to determine whether the operation performed is consistent with the intent indicated in the pre-execution record.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of auditable cryptographic agility, comprising:
receiving, by a cryptographic agility system, a request to perform a cryptographic operation related to an application;
selecting, by the cryptographic agility system, a cryptographic technique for performing the cryptographic operation based on contextual information associated with the request;
performing, by the cryptographic agility system, the cryptographic operation using the cryptographic technique; and
writing, by the cryptographic agility system, data related to selecting the cryptographic technique to a secure digital ledger.

2. The method of claim 1, wherein writing the data related to selecting the cryptographic technique to the secure digital ledger occurs prior to performing the cryptographic operation using the cryptographic technique, and wherein the data related to selecting the cryptographic technique written to the secure digital ledger is used in determining to proceed with performing the cryptographic operation using the cryptographic technique.

3. The method of claim 1, wherein writing, by the cryptographic agility system, the data related to selecting the cryptographic technique to the secure digital ledger comprises writing, to the secure digital ledger, indications of:
the contextual information;
the cryptographic technique; and
one or more characteristics of the cryptographic technique related to selecting the cryptographic technique.

4. The method of claim 3, wherein writing, by the cryptographic agility system, the data related to selecting the cryptographic technique to the secure digital ledger further comprises writing, to the secure digital ledger, an indication of one or more policies related to selecting the cryptographic technique.

5. The method of claim 1, further comprising:
determining, by the cryptographic agility system, an update comprising an addition, removal, or modification of a given policy or a given cryptographic technique; and
writing, by the cryptographic agility system, information related to the update to the secure digital ledger.

6. The method of claim 1, further comprising analyzing, by an auditing component, the data related to selecting the cryptographic technique on the secure digital ledger to determine compliance with one or more conditions.

7. The method of claim 6, wherein the auditing component comprises a self-executing program on the secure digital ledger.

8. The method of claim 6, wherein, based on the analyzing, one or more remedial actions or notifications are performed by the auditing component or one or more third parties.

9. The method of claim 6, wherein the analyzing involves utilizing one or more machine learning models.

10. The method of claim 1, further comprising, writing, by the cryptographic agility system, a pre-execution record related to selecting the cryptographic technique to the secure digital ledger prior to performing the cryptographic operation using the cryptographic technique.

11. A system for auditable cryptographic agility, comprising:
at least one memory; and
at least one processor coupled to the at least one memory, the at least one processor and the at least one memory configured to:
receive, by a cryptographic agility system, a request to perform a cryptographic operation related to an application;
select, by the cryptographic agility system, a cryptographic technique for performing the cryptographic operation based on contextual information associated with the request;
perform, by the cryptographic agility system, the cryptographic operation using the cryptographic technique; and
write, by the cryptographic agility system, data related to selecting the cryptographic technique to a secure digital ledger.

12. The system of claim 11, wherein writing, by the cryptographic agility system, the data related to selecting the cryptographic technique to the secure digital ledger comprises writing, to the secure digital ledger, indications of:
the contextual information;
the cryptographic technique; and
one or more characteristics of the cryptographic technique related to selecting the cryptographic technique.

13. The system of claim 12, wherein writing, by the cryptographic agility system, the data related to selecting the cryptographic technique to the secure digital ledger further comprises writing, to the secure digital ledger, an indication of one or more policies related to selecting the cryptographic technique.

14. The system of claim 11, wherein the at least one processor and the at least one memory are further configured to:
determine, by the cryptographic agility system, an update comprising an addition, removal, or modification of a given policy or a given cryptographic technique; and
write, by the cryptographic agility system, information related to the update to the secure digital ledger.

15. The system of claim 11, wherein the at least one processor and the at least one memory are further configured to analyze, by an auditing component, the data related to selecting the cryptographic technique on the secure digital ledger to determine compliance with one or more conditions.

16. The system of claim 15, wherein the auditing component comprises a self-executing program on the secure digital ledger.

17. The system of claim 11, wherein the secure digital ledger comprises a hash chain.

18. A non-transitory computer-readable medium storing instructions that, when executed by one or more processors, cause the one or more processors to:
receive, by a cryptographic agility system, a request to perform a cryptographic operation related to an application;
select, by the cryptographic agility system, a cryptographic technique for performing the cryptographic operation based on contextual information associated with the request;
perform, by the cryptographic agility system, the cryptographic operation using the cryptographic technique; and
write, by the cryptographic agility system, data related to selecting the cryptographic technique to a secure digital ledger.

19. The non-transitory computer-readable medium of claim 18, wherein writing, by the cryptographic agility system, the data related to selecting the cryptographic technique to the secure digital ledger comprises writing, to the secure digital ledger, indications of:
the contextual information;
the cryptographic technique; and
one or more characteristics of the cryptographic technique related to selecting the cryptographic technique.

20. The non-transitory computer-readable medium of claim 19, wherein writing, by the cryptographic agility system, the data related to selecting the cryptographic technique to the secure digital ledger further comprises writing, to the secure digital ledger, an indication of one or more policies related to selecting the cryptographic technique.
